(19) United States
(12) Patent Application Publication
(10) Pub. No.: US 2013/0132523 A1
(43) Pub. Date: May 23, 2013

(54) SYSTEMS FOR THE INTEGRATED DESIGN, OPERATION AND MODIFICATION OF DATABASES AND ASSOCIATED WEB APPLICATIONS

(71) Applicants: THOMAS LOVE, Crowell, CT (US); Paul JAMES, Ware, MA (US)

(72) Inventors: THOMAS LOVE, Crowell, CT (US); Paul JAMES, Ware, MA (US)

(21) Appl. No.: 13/478,772

(22) Filed: May 23, 2012

Related U.S. Application Data
(60) Provisional application No. 61/489,024, filed on May 23, 2011.

(51) Int. Cl. H04L 29/06

(52) U.S. Cl. CPC H04L 65/60
USPC 709/219

(57) ABSTRACT

The described embodiment of the system includes business methods and software and hardware that acquires up to multi-gigabyte digital video files from digital cameras and other storage media, encodes the video files into formats in general use for playback on the Internet, acquires and manages all types of non-video files and delivers digital video and non-video files to remote storage for display using encryption algorithms and file compression algorithms. The system consists of digital cameras, personal computers, software and remote servers. The video-file-management software manages the process of acquiring video files from removable storage and all types of files from personal computers, manages the process of encoding movie files, annotating and editing movie files, annotating non-movie files, and compressing, encrypting and uploading such files to remote storage. The video-file-management software divides long movie files into two-minute segments to make editing, recombining and uploading simpler and more reliable.

### CROSS-REFERENCE TO RELATED APPLICATIONS

This application claims the benefit of Provisional Patent Application Docket No. 61/488,596 and U.S. Provisional Patent Application No. 61/489,024 (and duplicate No. 61/490,101) and U.S. Provisional Patent Application No. 61/494,465 which are incorporated by reference.

### BACKGROUND OF THE INVENTION

1. Field of the Invention

This application relates to digital video files, digital video cameras, software conversion of video file formats, end-user software to convert and manage digital video files and non-video digital files, and delivery of such files to and from remote internet-based servers.

2. Description of Related Art

Users who want to make long (meaning more than about 20 minutes) digital videos and display them on internet-based systems currently have a series of difficult challenges. These include complexity of encoding, managing extremely large files, poor file naming systems, complexity of video editors, poor security and unreliable internet connections.

Multi-hour video files are hundreds of megabytes in size, and can be gigabytes in size. Copying them from various solid state storage devices used in cameras can take considerable amounts of time, and the process is easy to interrupt and cause failure and damage to the files.

Digital cameras use simple sequentially numbered file names to name video files. If the files are removed from the storage device, the cameras uniformly restart these simple file name sequences at the beginning, resulting in duplicate file names.

Due to the inherent unreliability of the Internet, and the efforts of ISPs to reduce bandwidth consumption by customers, uploading very large files for the average end user is a failure prone process. Uploads of files larger than 500 megabytes fail frequently. This makes it extremely difficult for typical end-users to upload hour long and greater movies to internet storage and display systems. Most user generated videos are limited to ten minutes or less because ofthis issue.

Native video file formats used by digital cameras are intended for DVD display and are not suitable for in-browser display. In order to make the native files suitable, they need to be re-encoded in formats intended for use on the Internet such as H.264 format with appropriate settings. This is accomplished using complex software tools like FFMPEG. This encoding process and software is complex and far beyond the capabilities of typical end-users.

Editing software is complex and too difficult for the typical end user to use. This means that either users have to be satisfied with raw video (including dead air, irrelevant or embarrassing footage, etc.) or they generally cannot make usable videos. It also means that frame rates and audio rates, which should be adjusted to fit the nature of the video and the limitations of web delivery, must be left at the defaults of the camera, which will be on average inappropriate for any given video.

Native non-video file formats are not suitable for in-browser display. In order to make the native files suitable, they need to be converted to formats intended for use on the Web, such as HTML5 and FLV with appropriate settings. This is accomplished using a sequence of complex software tools. This conversion process and software is complex and far beyond the capabilities of typical end-users.

Current systems for managing these processes are not secure and do not comply with security standards such as HIPAA.

### BRIEF SUMMARY OF THE INVENTION

The embodiment of the system described herein consists of the following:
digital cameras
desktop PCs
programmable telephones
desktop video and non-video file processing application (AVNFPA@)
storage area networks
open source video encoders and compression/encryption programs
open source PDF, HTML5 and FLV print drivers and converters
cloud based remote host software and systems that confirm user accounts, further process incoming video files and non-video files, store files and display video and non-video files over the Web, and provided editing capabilities through web browsers
content delivery networks
business methods to manage the system

The system is a collection of software, hardware and methods that for the first time enables end users to create, encode, upload to internet based servers, edit online and display videos of any length including multi-hour videos, as well as non-video files of any size. The VNFPA controls the acquisition of video and non-video files from digital storage devices, re-naming files and controlling associated file management, simplifying encoding and providing a reliable method of uploading gigabyte size video files along with associated meta-data and uploading and managing non-video files.

The VNFPA is software that consists of
an end-user presentation layer executable,
software that manages moving, renaming and deleting files stored on removable storage devices,
software which re-encodes video files into appropriate formats such as H.264 with the appropriate settings for display over the Web
software which manages the upload process to the cloud
encryption methods which comply with HIPAA and other statutes which require high security.

The cloud system includes
user security systems
file servers and video servers to manage the presentation and delivery of the video and non-video files
software to process and manage video files and non-video files, convert non-video files to formats appropriate for display on the Web, and edit video and non-video files, and stage video and non-video files and segments thereof for download to users
content delivery networks

### BRIEF DESCRIPTION OF THE DRAWINGS

FIG. 1 is an overview of the components of the system.

FIG. 2 describes the process flow for the acquisition, management and uploading of a video or non-video file from re-writable removable storage with remote editing and remote display.

FIG. 3 describes the cloud software process for handling incoming video and non-video files.

FIG. 4 describes the editing process for video and non-video files on the cloud system.

### DETAILED DESCRIPTION OF THE INVENTION

### Uploads

This system includes the description of the elements of associated U.S. Provisional Patent Application No. 61/489,024.

The system handles files in the following source process streams:
digital video files and photo files stored on removable storage devices such as digital cameras and SD cards
digital video files and photo files stored on a PC
non-video files stored on any device that can be used by a PC as a storage device
videos and non-video files created or stored on programmable telephones

Digital video files (particularly large files) create difficult management issues for users:
very large file sizes,
very slow storage media on digital cameras
redundant file naming systems
loss of meta-information related to the video in the course of processing
the high probability that the user will unintentionally interrupt the lengthy file encoding and file transfer process
security

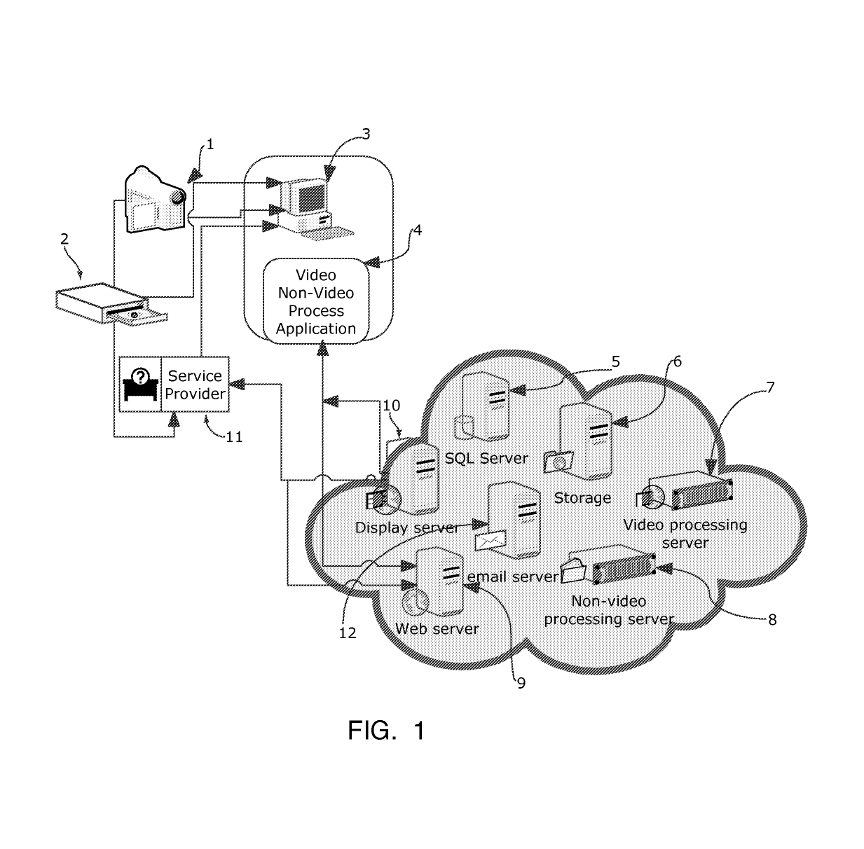

FIG. 1 is an overview of the components of the system.

Digital camera, FIG. 1, item 1. The source of the videos (and JPEGS) for the system is digital video cameras. All major camera types are supported because all major video formats are supported. The cameras also act as removable storage for the personal computer described below.

Other removable storage, FIG. 1, item 2. This represents sources of video and non-video files other than from cameras. This includes DVDs, USB drives and the like. The system can handle files from these sources.

Personal computer, FIG. 1, item 3. The personal computer operates the video and non-video file processing application and acts as an additional source of video and non-video files.

VNFPA, FIG. 1, item 4. This application handles the acquisition, organization, encoding, conversion, storage, encryption and transfer of all video and non-video files used by the system. It has a number of modes of operation, which vary by the degree of automation desired by the user and the type of file being processed.

Table 1 describes the components of the VNFPA. These components are all delivered as part of the VNFPA.

TABLE 1

| | component | description |
|---|---|---|
| 1 | User interface | The user interface application controls the interaction between the |
| | application | user and all of the components of the VNFPA, and obtains security |
| | | information from the user such as local usernames and passwords |
| | | and remote storage user names and interacts with the remote SQL |
| | | server through an encrypted web service to confirm and store such |
| | | security information. It also provides file annotation tools to the |
| | | user for both video and non-video files. |
| 2 | File acquisition | For security reasons this executable is driven by passing environment |
| | executable | variables rather than command line options (Windows readily |
| | | discloses command line options but not environment variables in |
| | | child environments). It has no user interface. This executable |
| | | manages the transfer of video and non-video files from their original |
| | | storage media into the file library of the VNFPA. It also securely |
| | | erases files from their original storage media when so requested by |
| | | the user (for compliance with laws like HIPAA). |
| 3 | Video encoding | This is an environment variable driven executable without a user |
| | executable | interface. It manages the process of encoding original video files |
| | | into proper formats for the Web. The video encoding executable |
| | | uses in this embodiment open source programs such as |
| | | MEDIAINFO, FFMPEG, HANDBRAKE and X264. The programs |
| | | analyze and encode video files, putting them in the correct format for |
| | | display in Web Browsers with the correct characteristics for display |
| | | across the internet. It encodes video files into short segments (e.g., |
| | | two minutes). This executable is controlled by the user interface |
| | | application. |
| 4 | Upload | This is an environment variable driven executable without a user |
| | download | interface. It uses in its operations in this embodiment two open |
| | management | source programs, S3 (with provides an upload download link to |
| | executable | Amazon = s S3 cloud storage service) and 7ZIP, an open source |
| | | compression and encryption program. The upload download |
| | | executable is controlled by the user interface application and is used |
| | | as part of the upload download process to and from remote storage. |
| 5 | Archiving | This is an environment variable driven executable without a user |
| | executable | interface. It enables the user to archive video and non-video files to |
| | | CD-ROMs and DVDs in a compressed and secure manner, |
| | | compliant with statutes like HIPAA. |

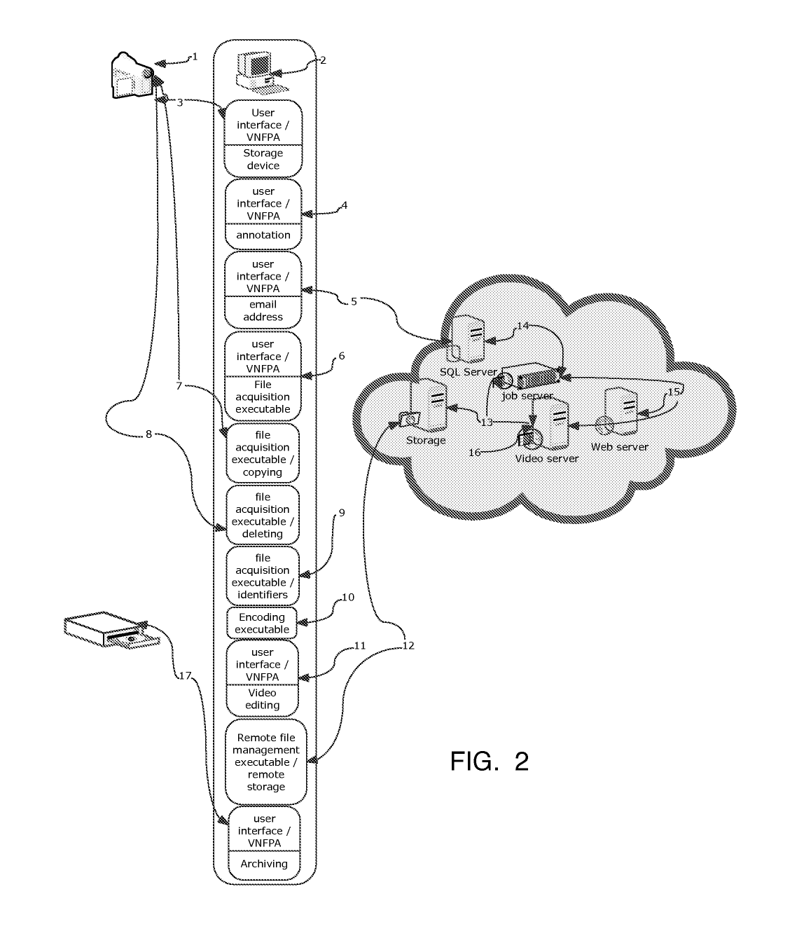

FIG. 2 describes the process flow for the acquisition, management and uploading of video and non-video files from PC or camera based storage to cloud storage.

User and digital camera, FIG. 2, item 1. The user creates a video with a digital camera.

User and personal computer, FIG. 2, item 2. The user connects the digital camera to the personal computer running the VNFPA, causing the digital camera=s storage device to be recognized as a removable storage device by the personal computer. In the case of a non-video file, the user would direct the VNFPA to locate the non-video file on the PC=s storage devices.

User and VNFPA, FIG. 2, item 3. The user starts the VNFPA and has it interrogate the personal computer for a list of removable storage devices and presents that list to the user. The user selects the camera=s storage device. The VNFPA runs the open source program MEDIAINFO against each file and creates an INI file associated with each file, and determines whether each file is a video (v), image (I), sound (s) or other (o, meaning not video, image or sound). The VNFPA prepares a list of all video files and all image (JPEG) files on the camera and temporary thumbnails of each file and presents that list to the user.

User and VNFPA and annotation, FIG. 2, item 4. The user decides which video files and non-video files should be included in the system, and whether the selected files should be deleted from the storage device (for security purposes). For each file to be included, the user may add informational tags of the nature key=value. .The tags are temporarily stored in the associated INI file.

User, VNFPA, email address, remote database server, FIG. 2, item 5. The user enters their system user name and password, which is validated through a web service on a web server connected to the database server and which returns the use=s file encryption key. The user can also associate an additional user name with each file, which must be valid on the remote system. The VNFPA sends a rest inquiry to the remote SQL server, confirming the validity of the additional user name . The additional user name forms part of the amended file name of the file. This additional name causes the file to be transferred to the additional named user=s account after the upload is complete. This enables a service bureau style operation, where one user prepares files for another, while still enforcing security - the only security credentials used are those already known to the sending user. The remote database server is described in associated U.S. Provisional Patent Application No. 61/489,024.

An alternative process that the end user can employ for automated video and picture file (AJPEG@) acquisition is the following:
the user enters the user=s user name and password in the VNFPA
the user connects the video camera to the PC running the VNFPA
the user selects the automatic processing feature in the VNFPA
the VNFPA interrogates the storage device on the VNFPA for JPEG files using MEDIAINFO, and immediately starts processing as set forth below
the VNFPA interrogates the storage device on the VNFPA for video files using MEDIAINFO, and immediately starts processing them as set forth below
the VNFPA thereafter periodically interrogates the storage device on the VNFPA for more JPEGS and video files (in case the camera is in real time use at the time) and as soon as any such new files are unlocked by the camera and are therefore no longer in use, the VNFPA processes the files as set forth below.

This alternative process reduces the workload of the user and permits near simultaneous streaming and video encoding.

Another alternative is to select a directory on a disk drive or other storage device, whereupon the VNFPA will poll then entire directory structure constantly for unlocked video and picture files, and then, once found, process them as herein described. This enables the transfer of entire storage area networks for files.

Multiple copies of the VNFPA can be run on the same PC or on multiple PCs connected to a network. All of the copies can poll storage data sources. The multiple instances of the VFNPA can coordinate their operations by jointly managed locking systems. On such system is that each instance of the VNFPA (a) creates a permanent unique ID for itself and (b) lists each data file that it is processing in a jointly accessible directory or file. In this manner, multiple copies of the VNFPA can work on, for example, the same storage network and avoid conflicts with each other regarding the allocation of files to work on. When an instance of the VNFPA selects a file to work on, it checks the jointly shared locking directory or file to see if another instance of the VNFPA is working on the same file, and if so, the instance in question selects other files until it finds one that isn=t being worked on by another instance.

VNFPA and file acquisition executable, FIG. 2, item 6. Once the user has completed the review of the storage device, the VNFPA launches the file acquisition executable. The file acquisition executable copies the source file to the target working directory and names the target file as follows:
file type (v video I image s sound o other)˜contact email address (user=s or additional)˜four digit year˜mmdd˜disk volume Id˜hhmmss’original size in bytes' encoding status’sequence number’processing status’orignal file name_extension.original file extension

An example is: a video file that was name mov001.mod on the storage device would become:
v˜support@lookinlearn.com˜2010˜0809˜57BF-22A1˜090451’6512345678’000’00’00’mov001_mod.mod

This file naming task is crucial to the robustness and security of the system. Digital cameras typically repetitively use simple sequentially numbered file names. This simple names would create constant conflict in a large system. The names used in this embodiment are for all practical purposes guaranteed to be unique across all cameras. In addition, by embedding the owner=s email in the file name, the system improves the security of the process—the owner ofthe file is always automatically known. The associated INI files are stored with them using the same name as the file (with the extension of INI) and in the working directory of the VNFPA.

File acquisition executable copying, FIG. 2, item 7. The file acquisition executable then copies the original files into working directory of the VNFPA. This copying is done in 10 megabyte chunks. This chunking creates a robust and restartable copying process that can readily handle multi-gigabyte files. Video files can be so large and take so long to copy that users can interrupt the process by accident by disconnecting the camera or turning off the personal computer. This 10 megabyte process, combined with distinctive file names and meta information in the associated INI files means that interrupted copying processes can be restarted immediately upon re-connection with the removable storage device, in the appropriate data location (where the target file ends) in the original file so as to avoid duplicative copying.

File acquisition executable deleting, FIG. 2, item 8. Files that have been marked for deletion from the storage device (which usually will be all the files on the storage device) are first overwritten with random data, renamed randomly, and then deleted. This is a security measure to ensure compliance with standards like HIPAA.

File acquisition process identifiers, FIG. 2, item 9. Once the file acquisition executable has copied a file in its entirety into the VNFPA, it changes the encoding status identifier from 00 to 01, and launches the encoding executable.

Encoding executable, FIG. 2, item 10. The encoding executable first changes the process status identifier for the file to 01 from 00, to indicate that the file is in the encoding process.

Then, in the case of video files, the encoding executable then uses FFMPEG or X264 or HANDBRAKE to create a series of two minute long sequential encoded segment movies from the original movie (the last segment will be the length of the remaining video after all the preceding two minute segments have been made). The file names of the segments are the same as the original file, with then exception the encoding status of the 2 minute segments is 02, and the sequence numbers in the file names indicate the order in which the 2 minute segments were created. As each 2 minute segment is completed, the encoding executable records this fact in its own INI file, and changes the process identifier for the 2 minute segments and the associated INI file to 49, indicating that they are ready for upload. When all of this has been completed, the original file has its process identifiers changed to 49 to indicate that this step has been entirely completed, and based on user choice in the VNFPA, the original file is ready for upload.

In the case of image and non-video files, the encoding executable changes their process status to 49 immediately (along with their associated INI files), to indicate that these files are ready for upload.

File transfer executable, FIG. 2, item 11. The remote file management executable (AFTE@) is then launched by the encoding management executable. The remote file management executable uses the open source program 7ZIP to compress each file marked with a process status (and its associated INI file) of 49 into a compressed file or series of compressed files, each of which is 10 megabytes in size or less. The FTE uses the user=s encryption key obtained earlier to encrypt the compressed files for security purposes. The FTE then executes a REST command against the web server, and, using the username and password of the local user, obtains the hash value for the user=s user account id and group account id from the database server, obtains a cloud file upload authorization URL from the web server, prepends the user=s hashed user account id and group account id to the name of the uploaded file, and executes a REST upload over HTTPS to the cloud based storage. Compressed files are uploaded in reverse numerical sequence when there is more than one 10 megabyte compressed. Immediately prior to upload, it executes an inquiry against the cloud system to determine if the file is already present on the cloud, and if not, uploads the file to the cloud storage service. This provides a robust and restartable system that withstands interruptions by users. It makes it possible to upload multi gigabyte files reliably, because if the process is interrupted at any point, the RFME restarts where the interruption occurred, not at the beginning of the process.

The upload process can use FTP, HTTPS, REST or SOAP depending on the remote protocol. In this embodiment, the method is REST over HTTPS using Amazon=s S3 service. If the file upload is interrupted then it is restarted after the last completed segment upload.

Remote incoming job executable (ARIJE@) , FIG. 2, item 12, remote job server, FIG. 2, item 13, remote database server, FIG. 2, item 14. The job executable on the remote job server polls the S3 upload directories on the cloud storage services. Once finding a compressed file with a sequence number of 0 (meaning it is either the only compressed file, or the first of a series, and since the series was uploaded in reverse order, all the other files in the series are already present), the RUE

Table 2 describes the process steps of the RUE.

TABLE 2
Process

The RIJE moves the file to temporary storage and extracts the files from
the compressed files and reassembles them
If the file is a video file, then the RIJE makes a thumbnail JPEG of the file
and stores the JPEG in permanent cloud storage.
If the file is an image file (JPEG), the RIJE makes a thumbnail of the
image file and likewise stores the thumbnail in permanent cloud storage
and updates the database.
If the file is a sound file, the file is moved to permanent cloud storage
If the file is an other file (non-video, non-image), then through associated
print drivers, the RIJE creates PDF files from the original, and
FLV/HTML5 files for display, and moves these files to permanent
storage.
If the file is an INI file, the tags are added to the tag table of the database
associated with the file by using the INI file = s file name.
If the file is an original file of any type, it is compressed using 7zip in
10 megabyte segments and stored in cloud storage for later download
by an authorized user.
The job executable updates the remote database server with the location
of the foregoing files in permanent storage. All associated files are
associated in database with the record that represents the original file
(the Amaster file record@), so all segments, thumbnails, PDFs, and
original remotely stored files are associated with the original file record.
In addition, all such records can be associated with new Avirtual@
master file records, thereby creating new Avirtual@ vides and
other files.

The remote job executable, the remote database server and remote job server are described in associated U.S. Provisional Patent Application No. 61/489,024.

Web server and web application, FIG. 2, item 15. The web application displays the master video files in its 2 minute segments as a continuous movie, shows each two minute thumbnail and enables the user to edit the videos. It displays non-video files as HTML5 and FLV on a page by page basis. The web application enables titles, subtitles and skipped segments and pages. It enables creating new master movie with new segments by re-combining existing segments from other master movies. If a section of a video or a page of a non-video file is requested to be deleted, the web application deletes the associated database record from the master record. The web server and web application are described in associated application U.S. Provisional Patent Application No. 61/489,024.

Remote video display system, FIG. 2, item 16. The video display and management system is described in the associated U.S. Provisional Patent Application No. 61/489,024.

VNFPA archiving executable, FIG. 2, item 17. The VNFPA includes an archiving executable. The archiving executable will, upon request of a user, use 7ZIP to move the contents of the encoded and original directories into a series of 670 megabyte zip files, using the user owner=s password. If more than one user owner exists in these directories, then a separate series of zip files will be made for each. The file size of 670 megabytes is used because is most evenly divides into CD-ROMs and DVDs. Associated file information from the INI files will be put in text files associated with the zip files so the contents of the files can be identified. Then the files will be burned by the encoding executable using Windows IMAPI2 interface and erased from the personal computer. This archiving system is encrypted and complies with statutes like HIPAA.

Remote database server, FIG. 1, item 5. This is used to provide username/password security and manage job scheduling for the other remote devices. This is the database server described in the associated U.S. Provisional Patent Application No. 61/489,024.

Remote storage, FIG. 1, item 6. This is user controlled remote storage which is used to store user files on the remote system. In this embodiment Amazon=s S3 remote storage service is used.

Remote video processing server, FIG. 1, item 7. The remote video processing server runs a RUE which runs automatically on remotely stored files when requested by the user through the user=s local copy of the VNFPA. This is a job server as described in the associated U.S. Provisional Patent Application No. 61/489,024.

Remote video processing server, FIG. 1, item 8. The remote non-video processing server makes FLV, HTML5, PDF files and JPEG thumbnails out of each of the non-video files for presentation and makes a PDF file as an alternative to access to the original files (as a security measure). This is one of the job servers describe in the associated U.S. Provisional Patent Application No. 61/489,024.

Web server / web application, FIG. 1, item 9. The web server hosts an application which provides the same editing tools that the VNFPA does and through its interface with the database server, enables the organization of the video and non-video files for display. This is the web server and application described in the associated U.S. Provisional Patent Application No. 61/489,024.

Content Delivery Network, FIG. 1, item 10. The content delivery network/display server displays the encoded videos and FLV / HTML5 formatted non-video files to users. This is comprised of the a content delivery network and the video display server described in the associated U.S. Provisional Patent Application No. 61/489,024.

Service provider, FIG. 1, item 11. An alternative system provided to end users is a postal mail bases system. Users outsource the entire process to a service provider. The process works as follows:
the user creates movies with the user=s camera
the user removes the storage device from the camera (usually an SD card) and mails it to the outsourcer
the user uses a new storage device to make more movies
once the outsourcer receives the storage device, the outsource runs the VNFPA on behalf of the user
the outsourcer mails the storage device back to the user.

This greatly simplifies the process for end users. The user can make annotations and edits can be made on the cloud using the web application once the files have been uploaded.

Programable phone, FIG. 1, item 12. The web server interface can accept file uploads directly from programmable telephones. The uploads are stored on the job server and handled by a remote copy of the VNFPA as any other file would be.

Remote email server, FIG. 1, item 13. The VNFPA updates the owner of the files at each step via email. This is the email server described in the associated U.S. Provisional Patent Application No. 61/489,024.

### Display and Editing

Requests for display of files in a web browser are made by the user to the web server, FIG. 1, item 9. Files are located in cloud storage by the web server by reference to the database server, and displayed through standard web browser players either through the content delivery network or through a display server.

Video files are displayed as continuously playing two minute segments by the web server by association the database server to the master record of the original file. A video segments can be added, removed, reordered and pulled from various other videos by creating a new master record, and then through the user interface, adding segments in the desired order. A segment can be deleted from any movie master but the original movie master record by deleting the associating database record. Subtitles can be added to any segment by adding the subtitles to the database segment record. The web browser interrogates this record when playing the segment. A segment can have portions of it blocked by adding that command to the segment record, which is likewise interrogated by the web server when displaying the segment.

New sound tracks in the form of MP3 files can be overlaid on a video segment. If the segment record is updated to point to an additional MP3 file, then the web server will cause the web browser player to block the video segment=s imbedded sound track and play the new one instead.

Non-video files which are segmented into pages can be similarly edited with subtitles, similarly matched with new master records, reordered, blocked and deleted.

### Downloads

The web server can deliver snapshots of video, image and non-video files at the request of the user. The user can make a request for, in the case of a video, a frame at a certain point in the video, the original image in the case of the image, or a page in the case of a non-video file. In the case of an original file download request, or an image of non-video file page, the web server issues an immediately available download link for the file from cloud storage.

In the case of a video snapshot, the web server enters a job request in the job server. The job server executable pulls the original video from cloud storage on to temporary working remote storage, uses FFMPEG or a similar program to extract the requested frame in the form of a JPEG, deletes the temporary original, moves the snapshot to cloud storage and alerts the user through a job entry to the web application and the email server that the snapshot is available.

### Additional Embodiments

The VNFPA and the outsourcing system can be used with any remote display system including cloud based, generally internet based, or local area network based. The encoding compression software and non-video file conversion software can be any open source or closed-source program using public standards.

While the foregoing description of the system enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention

### CONCLUSION, RAMIFICATIONS AND SCOPE

The described system contains a number of major operational advances over the current art.

One of the design features of the system is robustness through restartability, provided by naming conventions, meta INI files, copy checking and chunking, and two minute movie segmenting.

All file names are changed to names that include the email address of the owner, the original file name, the file creation date, and the file size. This system guarantees distinctive, unique file names which make restarting interrupted file copies at the point of interruption accurate and reliable. If the source file is on non-rewriteable media, the source and target files can be accurately matched by comparing the source file name, source file size and source file creation date with the same information provided by the target file=s name.

Every time the system copies a file from one storage media to another, the target file is checked and if the file is present in full, the copy is skipped. If, for example, a user creates a movie master and uploads it, and then creates a second movie master using many of the same segments, those re-used segments will not be uploaded again. All file copies are done in 10 megabyte chucks. On the personal computer, the 10 megabyte chunks are appended to the target file. Remote copying is done by splitting the target file into a series of 10 megabyte sequentially numbered files which are then reassembled into a single file on the remote system. This technique enables restarting copies of large files at the point of failure rather than at the beginning. When a user is uploaded a five megabyte movie file to the remote system over many hours, and the upload gets interrupted at four megabyte mark, this system provides tremendous efficiency.

The two minute automatic segmenting of video files is a major operational advance. Video files are huge. They can be 3-10 gigabytes and larger. By splitting them into two minute segments, and presenting them in seamless play lists, the reliability and restartablility ofthe system is greatly improved. This two minute splitting, combined with the entire management ofthe video process, combined with the editing described below, is a significant advance.

Another design feature of the system which is also in part a product of the two minute segmenting is greatly improved and simplified editing. This is achieved by first splitting the videos into two minute segments, and then by providing the user with a reduced set of editing tools: titles, subtitles, skipping, deleting, and mixing and matching segments. Video editing software is complex and has a learning curve far beyond the patience and capacity of most end users. This software is simple and fast and meets the vast majority of the needs of users in industries such as education and medical. These techniques are a vast advance over the current state of the art. This is in part because current computer technology is severely taxed by multi gigabyte video files: in this system, no video segment is longer than two minutes. Secondly in environments like classrooms or seminars where the cameras may be left running all day, it is extremely easy to delete dead air in this system. It is extremely hard to do if the video hasn=t already been segmented.

Another design feature of the system is security. This is provided by embedding the owner=s email address in the file name right from the start and by the pervasive use of encryption on all remote systems and all archived copies. The email address enables secure tracking of files, and per email address encryption keys. The pervasive use of encryption and security is unique on the internet.

Another feature of the system is the ability to pull frames out of videos and pages out of non-video files and deliver individual frames and pages separately.

Another feature of the system is the alternative work flow methodologies offered to end users for video processing. The user can encode locally, and edit remotely (useful if, for example, an IT staff is managing the acquisition process but not the editing process). The end user can upload unencoded video files and encode and edit online (useful if the end user has inadequate CPU technology on their local personal computer, as encoding is extremely CPU intensive). And the user can simply mail the video files to the outsourcer.

I claim:

1. A method for the acquisition and management of digital files and their display and management through the internet, comprising:
a. communicating with a plurality of electronic storage devices via the internet;
b. copying files from said electronic storage devices;
c. storing said files and facilitating the download of said files; and
d. providing tools for the management of said files, said tools comprising a tool for delivering only a portion of one of said files.

2. The method of claim 1, said tools further comprising a tool for renaming files and a tool for encrypting files.

3. The method of claim 1, further comprising segmenting large files into smaller segments so that encoding and delivery can be managed in segments.

4. The method of claim 1, further comprising maintaining file-naming conventions for said files as to allow globally unique names to an unlimited number of files.

5. The method of claim 1, further comprising displaying such files in a web-compatible format, such as through web servers or content-delivery networks.

6. The method of claim 1, said tools further comprising a tool for editing via the internet one of said files.

7. The method of claim 1, further comprising providing for the encryption of all files while being transmitted to or from the cloud.

8. The method of claim 1, said files comprising video files.

9. The method of claim 8, wherein said portion of one of said files is an image from a video file.

10. An apparatus for the acquisition and management of digital files and their display and management through the internet, comprising:
a. a means of communicating with a plurality of electronic storage devices via the internet;
b. a means of copying files from said electronic storage devices;
c. a means of storing said files and facilitating the download of said files; and
d. a means of providing tools for the management of said files, said tools comprising a tool for delivering only a portion of one of said files.

11. The apparatus of claim 10, said tools further comprising a tool for renaming files and a tool for encrypting files.

12. The apparatus of claim 10, further comprising a means of segmenting large files into smaller segments so that encoding and delivery can be managed in segments.

13. The apparatus of claim 10, further comprising a means of maintaining file-naming conventions for said files as to allow globally unique names to an unlimited number of files.

14. The apparatus of claim 10, further comprising a means of displaying such files in a web-compatible format, such as through web servers or content-delivery networks.

15. The apparatus of claim 10, said tools further comprising a tool for editing via the internet one of said files.

16. The apparatus of claim 10, further comprising a means of providing for the encryption of all files while being transmitted to or from the cloud.

17. The apparatus of claim 10, said files comprising video files.

18. The apparatus of claim 17, wherein said portion of one of said files is an image from a video file.
